(19) United States
(12) Patent Application Publication
(10) Pub. No.: US 2024/0027208 A1
(43) Pub. Date: Jan. 25, 2024

(54) NEURAL NETWORK-BASED ROUTING USING TIME-WINDOW CONSTRAINTS

(71) Applicant: BRINGG DELIVERY TECHNOLOGIES LTD., Tel Aviv (IL)

(72) Inventors: AVIV TAMAR, Tel Aviv (IL); SHAY NATIV, Tel Aviv (IL); ELI SAFRA, Tel Aviv (IL)

(21) Appl. No.: 18/030,238

(22) PCT Filed: Oct. 4, 2021
(86) PCT No.: PCT/US2021/053443

§ 371 Date: Apr. 4, 2023

Related U.S. Application Data
(60) Provisional application No. 63/087,231, filed on Oct. 4, 2020.

(51) Int. Cl. G01C 21/34; G06N 3/092

(52) U.S. Cl. CPC G01C 21/3446; G06N 3/092

(57) ABSTRACT

Synthetic requests are received including coordinates randomly generated, time windows artificially generated, and time-on-site intervals randomly generated. Routes are simulated including a navigation sequence that includes locations corresponding to each synthetic request. A cost function (reflecting a time duration required for completion of the route) is applied to each simulated route to determine quality. A model is trained to artificially generate routes based on the determined quality. Real-world requests are received including real-world coordinates, time windows, and time-on-site intervals. The received real-world requests are projected onto a domain on which the model was trained by generating a distance matrix that reflects a fully-connected graph representing travel times between respective geographic locations corresponding to the real-world requests. Using the model as trained based on the simulated routes, a route is generated with respect to virtual locations. The route, as generated using the model, is transformed into real-world geographic coordinates. Actions are initiated with respect to the real-world geographic coordinates.

### CROSS-REFERENCE TO RELAYED APPLICATION

This application is related to and claims the benefit of U.S. Patent Application No. 63/087,231, filed Oct. 4, 2020, which is incorporated herein by reference in its entirety.

### TECHNICAL FIELD

Aspects and implementations of the present disclosure relate to data processing, and more specifically, to neural network-based routing using time-window constraints.

### BACKGROUND

Various devices, such as smartphones, tablet devices, portable computers, etc., can incorporate multiple sensors. Such sensors can receive and/or provide inputs/outputs that reflect what is perceived by the sensor.

Neural networks can include model(s) that can receiving input(s) and process such inputs through the model's interconnected nodes to generate output(s). Such model(s) can be trained using techniques including reinforcement learning (e.g., based on feedback received in relation to various actions).

Techniques and approaches such as combinatorial optimization can be used to attempt to compute improved or optimal solutions to various problems, e.g., based on a finite set of objects.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example device, in accordance with an example embodiment.

FIG. 3A is a flow chart illustrating aspects of a method, in accordance with example embodiments, for neural network-based routing using time-window constraints.

FIG. 3B is a flow chart illustrating further aspects of a method, in accordance with example embodiments, for neural network-based routing using time-window constraints.

FIG. 4 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to neural network-based routing using time-window constraints.

Existing technologies enable users to initiate operations and/or transactions that are to be fulfilled in a relatively short period of time. For example, food delivery applications/services enable users to order groceries and other items for prompt or immediate delivery. While such services may be advantageous to both merchants and customers, certain scenarios may pose particular challenges, particularly with respect to the routing and dispatch of drivers to fulfill requests/orders.

Additionally, in certain scenarios the resources available to fulfill such requests/orders may be finite and/or limited in various respects. For example, a limited number of drivers may be available to deliver certain orders in a specific location. Accordingly, in these and other scenarios and settings it may be advantageous to improve and/or optimize the dispatch of such drivers, e.g., by directing them along a route determined to take the least amount of time to complete.

Accordingly, described herein in various implementations are technologies that enable neural network-based routing using time-window constraints. The described technologies utilize machine learning to optimize the routing and dispatch of orders, e.g., based on numerous factors and constraints. Moreover, in certain implementations the described technologies further enable the models generated via the described techniques to be applied in broader contexts. Doing so can, for example, further increase the efficiency and effectiveness of the described technologies.

Accordingly, it can be appreciated that the described technologies are directed to and address specific technical challenges and longstanding deficiencies in multiple technical areas, including but not limited to machine learning, neural networks, and sensor-based route optimization. As described in detail herein, the disclosed technologies provide specific, technical solutions to the referenced technical challenges and unmet needs in the referenced technical fields, thereby providing numerous technical advantages and improvements upon conventional approaches. Additionally, in various implementations one or more of the hardware elements, components, etc., (e.g., sensors, interfaces, etc.) operate to enable, improve, and/or enhance the described technologies, such as in a manner described herein.

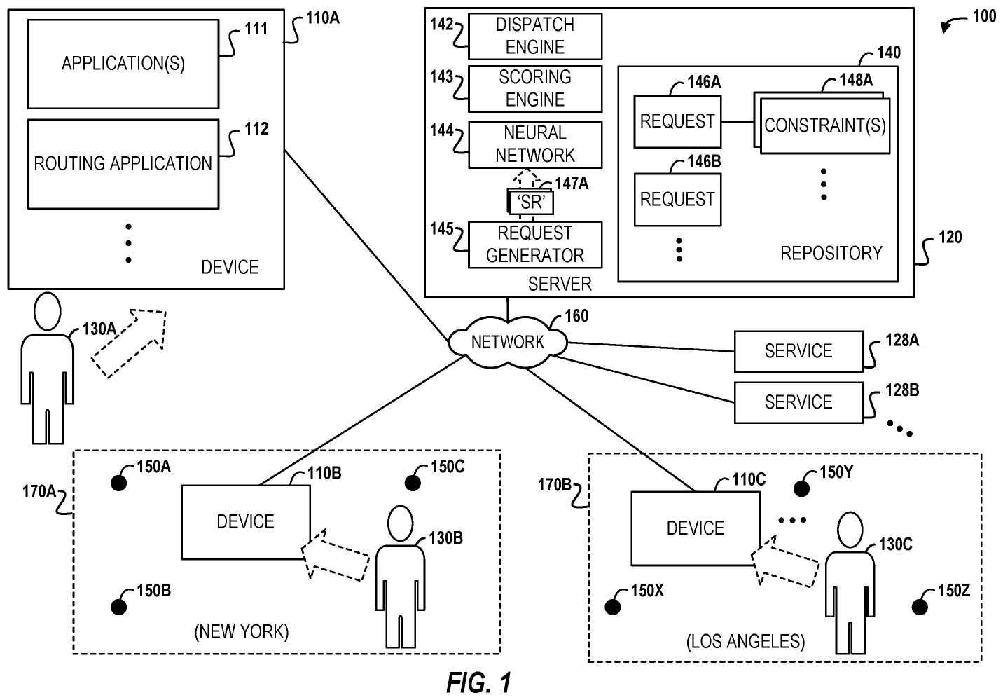

FIG. 1 depicts an illustrative system 100, in accordance with some implementations. As shown, system 100 includes devices 110A, 110B, and 110C (collectively, devices 110), server 120, and services 128A and 128B. These (and other) elements, components, machines, etc. can be connected to one another via network 160, which can be a public network (e.g., the Internet), a private network (e.g., a local area network (LAN) or wide area network (WAN)), or a combination thereof. Additionally, in certain implementations various elements may communicate and/or otherwise interface with one another.

Each of the referenced devices 110 can be, for example, a mobile device, a smartphone, a tablet computer, a smart watch, a personal computer, a terminal, a wearable device, a virtual reality device, an augmented reality device, a holographic device, and the like. Users 130A, 130B, and 130C (collectively, users 130) can be human users who interact with devices 110A-110C, respectively. For example, user 130A can provide various inputs to device 110A (e.g., via an input device/interface such as a keyboard, mouse, touchscreen, microphone—e.g., for voice/audio inputs, etc.). Device 110A can also display, project, and/or otherwise provide content to user 130A (e.g., via output components such as a screen, speaker, etc.). In certain implementations, a user may utilize multiple devices, and such devices may also be configured to operate in connection/coordination with one another (e.g., a smartphone and a smartwatch).

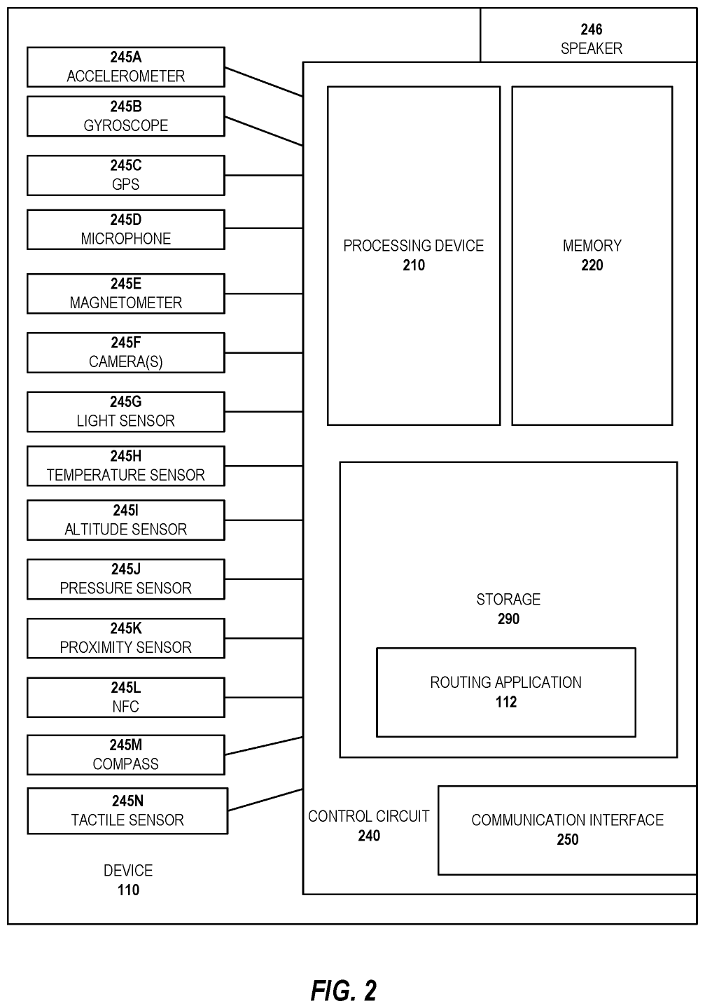

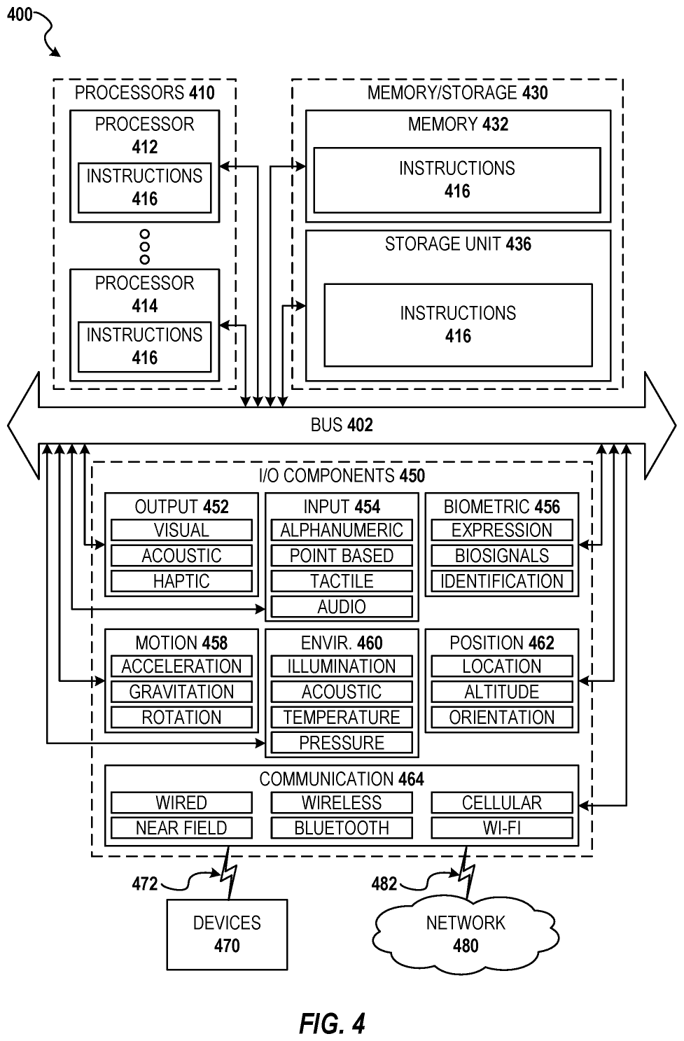

It should be understood that, in certain implementations, devices 110 can also include and/or incorporate various sensors and/or communications interfaces (including but not limited to those depicted in FIGS. 2 and 4 and/or described/referenced herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc. Additionally, in certain implementations device(s) 110 can be connected to and/or otherwise communicate with various peripheral devices.

By way of illustration, FIG. 2 depicts an example implementation of a device 110 (e.g., device 110A as shown in FIG. 1). As shown in FIG. 2, device 110 can include a control circuit 240 (e.g., a motherboard) operatively connected to various hardware and/or software components that serve to enable various operations, such as those described herein. Control circuit 240 can be operatively connected to processing device 210 and memory 220. Processing device 210 serves to execute instructions for software that can be loaded into memory 220. Processing device 210 can be a number of processors, a multi-processor core, or some other type of processor, depending on the particular implementation. Further, processor 210 can be implemented using a number of heterogeneous processor systems in which a main processor is present with secondary processors on a single chip. As another illustrative example, processor 210 can be a symmetric multi-processor system containing multiple processors of the same type.

Memory 220 and/or storage 290 may be accessible by processor 210, thereby enabling processing device 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 can also be fixed or removable.

As shown in FIG. 2, storage 290 can store routing application 112. In certain implementations, routing application 112 can be, for example, instructions, a mobile ‘app,’ etc., that can be loaded into memory 220 and/or executed by processing device 210, in order to enable a user of the device to interact with and/or otherwise utilize the technologies described herein (e.g., in conjunction with/communication with server 120).

A communication interface 250 is also operatively connected to control circuit 240. Communication interface 250 can be any interface (or multiple interfaces) that enables communication between user device 102 and one or more external devices, machines, services, systems, and/or elements (including but not limited to those depicted in FIG. 1 and described herein). Communication interface 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 110 to other computing devices, systems, services, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 110 can communicate with one or more other devices, systems, services, servers, etc., such as those depicted in FIG. 1 and/or described herein. Such devices, systems, services, servers, etc., can transmit and/or receive data to/from the user device 110, thereby enhancing the operation of the described technologies, such as is described in detail herein. It should be understood that the referenced devices, systems, services, servers, etc., can be in direct communication with user device 110, indirect communication with user device 110, constant/ongoing communication with user device 110, periodic communication with user device 110, and/or can be communicatively coordinated with user device 110, as described herein.

Also connected to and/or in communication with control circuit 240 of user device 110 are one or more sensors 245A-245N (collectively, sensors 245). Sensors 245 can be various components, devices, and/or receivers that can be incorporated/integrated within and/or in communication with user device 110. Sensors 245 can be configured to detect one or more stimuli, phenomena, or any other such inputs, described herein. Examples of such sensors 245 include, but are not limited to: accelerometer 245A, gyroscope 245B, GPS receiver 245C, microphone 245D, magnetometer 245E, camera 245F, light sensor 245G, temperature sensor 245H, altitude sensor 245I, pressure sensor 245J, proximity sensor 245K, near-field communication (NFC) device 245L, compass 245M, and tactile sensor 245N. As described herein, device 110 can perceive/receive various inputs from sensors 245 and such inputs can be used to initiate, enable, and/or enhance various operations and/or aspects thereof, such as is described herein.

At this juncture it should be noted that while the foregoing description (e.g., with respect to sensors 245) has been directed to user device 110, various other devices, systems, machines, servers, services, etc. (such as are depicted in FIG. 1 and/or described herein) can similarly incorporate the components, elements, and/or capabilities described with respect to device 110. It should also be understood that certain aspects and implementations of various devices, systems, servers, services, etc., such as those depicted in FIG. 1 and/or described herein, are also described in greater detail below in relation to FIG. 4.

In certain implementations, device 110 can also include one or more application(s) 111 and routing application 112. Each of application(s) 111 and routing application 112 can be programs, modules, or other executable instructions that configure/enable the device to interact with, provide content to, and/or otherwise perform operations (e.g., on behalf of a user). In certain implementations, such applications can be stored in memory of device 110 (e.g. memory 430 as depicted in FIG. 4 and described below). One or more processor(s) of device 110 (e.g., processors 410 as depicted in FIG. 4 and described below) can execute such application(s). In doing so, device 110 can be configured to perform various operations, present content to user 130, etc.

Examples of application(s) 111 include but are not limited to: internet browsers, mobile apps, ecommerce applications, social media applications, personal assistant applications, navigation applications, etc. By way of further illustration, application(s) 111 can include mobile apps that enable users to initiate various operations with third-party services 128, such as navigation services, food delivery services, ride sharing services, ecommerce services, websites, platforms, etc.

Routing application 112 can be, for example, instructions, an ‘app,’ module, etc. executed at device 110 that generates/provides notifications, information, updates to user 130 (e.g., a driver or delivery person) regarding various orders, deliveries, etc. For example, routing application can receive information from server 120 regarding new order(s) the driver can pick up (e.g., from a restaurant, grocery store, etc.) in order to perform a delivery. Routing application 112 can route the user to the corresponding locations (e.g., using various navigation techniques/technologies, including but not limited to one or more of application(s) 111, such as a navigation application).

For example, the driver can first be routed to a grocery store to pick up the order(s), and then (e.g., upon determining that the driver has received the orders for delivery) to the first (and then second, third, etc.) delivery on the driver's delivery route. Additionally, routing application 112 can configure device 110 to communicate with various other devices, machines, services, etc., (e.g., server 120) in order to update such devices, etc. regarding the user's present location. In doing so, the real-time location of various drivers/devices can be accounted for in (a) assigning particular deliverie(s) to particular driver(s), (b) in providing delivery timeframe estimates to ordering users, and/or in performing various other operations, such as are described herein. Additionally, in certain implementations the described technologies can account for locations associated with various orders, the availability of certain drivers to fulfill such orders, historical data, and/or other constraints, in order to optimize the dispatch and routing of such orders/drivers, as described in detail herein.

It should be noted that while application(s) 111 and 112 are depicted and/or described as operating on a device 110, this is only for the sake of clarity. However, in other implementations such elements can also be implemented on other devices/machines. For example, in lieu of executing locally at device 110, aspects of application(s) 111 and 112 can be implemented remotely (e.g., on a server device or within a cloud service or framework).

Server 120 can be a rackmount server, a personal computer, a mobile device, a smartphone, any combination of the above (e.g., as configured within a cloud-computing framework), or any other such computing device capable of implementing the various features described herein. Server 120 can include components such as data repository 140, dispatch engine 142, scoring engine 143, neural network 144, and request generator 145.

In certain implementations, server 120 can also include and/or incorporate various sensors and/or communications interfaces (including but not limited to those depicted in FIG. 2 and described in relation to device(s) 110). The components can be combined together or separated in further components, according to a particular implementation. Additionally, in some implementations, various components of server 120 may run on separate machines (for example, repository 140 can be a separate device). Moreover, some operations of certain of the components are described in more detail herein.

Data repository 140 can be hosted by one or more storage devices, such as main memory, magnetic or optical storage-based disks, tapes or hard drives, NAS, SAN, and so forth. In some implementations, repository 140 can be a network-attached file server, while in other implementations repository 140 can be some other type of persistent storage such as an object-oriented database, a relational database, and so forth, that may be hosted by the server 120 or one or more different machines coupled to server 120 via the network 160, while in yet other implementations repository 140 may be a database that is hosted by another entity and made accessible to server 120. In other implementations, repository 140 can be implemented as within a distributed or decentralized system/environment (e.g., using blockchain and/or other such decentralized or distributed computing/storage technologies).

In certain implementations, repository 140 can store data pertaining to and/or otherwise associated with various requests, locations, and/or other information. In certain implementations, such stored information can pertain to aspects of delivery requests (e.g., grocery orders for delivery, etc.). In certain implementations, such requests/orders may be received from various services such as service 128A and service 128B (collectively, services 128). Moreover, in certain implementations such requests/orders may originate from various customers which may be positioned at or otherwise associated with specific geographic locations (e.g., geographic coordinates of a customer's device, a delivery address of an order, etc.).

Services 128 can be, for example, third-party services that enable users to purchase goods for shipment, place grocery/food orders for delivery, and/or any other such services. Accordingly, upon receiving an order (e.g., for grocery delivery, flowers, gifts, etc.), such a service 128 can provide or transmit a request to server 120. Such a request can include, for example, contents of the order (e.g., grocery items), a location identifier (e.g., an address to which the order is to be delivered to), and/or other values, parameters, information (e.g., the time the order was placed, the time it must be delivered by, etc.). In certain implementations, the referenced orders, information, etc., can be stored in repository 140. Accordingly, repository 140 can maintain real-time and/or historic records of orders received (e.g., orders submitted to a particular store).

For example, as shown in FIG. 1, repository 140 can include one or more requests such as request 146A, request 146B, etc. (collectively, request(s) 146). Such requests can include and/or incorporate information associated with various requests, orders, etc., that are received, e.g., from various users, services, etc. For example, in certain implementations a request can include contents of a food delivery order (e.g., menu items), a location identifier (e.g., an address to which the order is to be delivered to), a user identifier (e.g., the name and/or contact information of the user associated with the order) and/or other values, parameters, information (e.g., the time the order was placed, the time it must be delivered by, other requests or specifications, etc.).

Additionally, in certain implementations, one or more of the referenced requests 146 can be associated with one or more constraints (e.g., constraint(s) 148A, as shown). Such constraints can be, for example, various parameters, ranges, etc., within or with respect to which associated request(s)/order(s) are to be prepared, delivered, etc. Examples of such constraints include but are not limited to: time constraints pertaining to order preparation and/or delivery, time and temperature control requirements (e.g., for safety/health purposes), time constraints reflecting when an order must leave a restaurant, etc., in order to meet customer expectations, and/or other such customer expectations (which can vary, for example, with respect to a fixed delivery time, a particular timeframe, a certain time duration after an order is placed, etc.). Further aspects of the referenced constraints are described in detail herein.

Additionally, in certain implementations, repository 140 can store data pertaining to various drivers/delivery personnel, orders, etc., that are handled/managed by the described technologies. For example, as noted above, device(s) 110 (which may correspond to various drivers) can routinely provide their current geographic location to server 120. Such information can be stored (e.g., in repository 140), thereby reflecting real-time and/or historic record(s) of such locations. The referenced location(s) can be further accounted for in dispatching requests/orders, coordinating and optimizing aspects of the preparation of such requests/orders, and performing other operations (e.g., as described herein).

As shown in FIG. 1, server 120 can also include dispatch engine 142, scoring engine 143, neural network 144, and request generator 145. Dispatch engine 142 can be, for example, an application, module, instructions, etc., executed and/or otherwise implemented by server 120 that enables the real-time distribution of various orders to respective drivers. For example, restaurant orders received from a food ordering service 128 can be associated with/distributed to various drivers based on various criteria (e.g., availability, location, capabilities, etc., of the driver(s)). In certain implementations, dispatch engine 142 can utilize neural network 144 to generate and/or otherwise compute route(s), such as routes for delivery of such requests/orders. Such a route can, for example, include an arrangement or sequence of deliveries that is determined to be sufficient and/or optimal based on various criteria (e.g., likely to be completed in the shortest time interval). As described herein, by utilizing neural network 144, previously computed delivery routes (including those computed with respect to other geographic locations) can be leveraged in order to optimally route currently pending orders.

Neural network 144 can be, for example, a data structure configured to receive inputs corresponding to various request(s)/order(s) and optimizes the routing of such request(s). As described in detail herein, neural network 144 can include a model trained using reinforcement learning and/or other such machine learning techniques.

In certain implementations, during an initial training phase, the model can be trained using synthetic or simulated requests (such as those generated by request generator 145). Such synthetic requests can be, for example, generated (e.g., randomly generated) requests that reflect constraints and/or parameters that may correspond to real-world scenarios. Such constraints can include but are not limited to a time window, which can reflect, for example, a chronological interval during which a request is to be fulfilled (e.g., delivered to a defined geographic location). Other example constraints can include demand (e g, at each node), capacity (e.g., the number of orders/objects a driver or vehicle is capable of transporting at a given time), etc.

In one example implementation, neural network 144 can be trained based on requests/inputs such as synthetic or randomly generated requests/inputs that may resemble or correspond to real-world requests. For example, as shown in FIG. 1, request generator 145 can generate numerous synthetic requests (“SR”) 147A, etc. Such synthetic requests 147 can include or incorporate random location coordinates or other such geographic identifiers (e.g., within a defined area, such as a city, radius from a certain point, etc.). By way of further example, request generator 145 can generate synthetic requests reflecting randomly or artificially generated time window constraints (e.g., chronological intervals during which a request is to be fulfilled, such as delivery of an order between 10:00 AM and 11:00 AM). It should be understood that the referenced constraints are provided by way of example, and that any number of additional constraints can also be incorporated. Such synthetic requests 147 can be provided to/received by neural network 144, as shown.

By way of further illustration, neural network 144 can receive various requests/inputs such as synthetic requests 147 (e.g., as generated by request generator 145), each of which includes parameters or constraints associated with a real-world request (e.g., an order to be dispatched to a driver for delivery to a specific location). In certain implementations, such synthetic requests can include constraints reflecting respective delivery locations. In certain implementations, such location constraints can, for example, be expressed as Euclidean distances in relation to one another (reflecting, for example, the amount of time to travel between one point and another). Each such synthetic request can be provided as input(s) to neural network 144.

In certain implementations each such request can be assigned or associated with various constraints such as a time window constraint(s). Such a time window can reflect, for example, a chronological interval during which a delivery is to be made (e.g., a delivery of a particular item to a particular location). It should be understood that different orders may have different time windows (e.g., one order may be associated with a constraint requiring that it be delivered within a 60 minute time window while another order may be associated with a constraint requiring that it be delivered within a 180 minute time window).

In certain implementations, the referenced request(s) can also be associated with various additional constraints. For example, a time-on-site constraint can reflect an amount of time a driver is expected to spend at a location (after arriving there) in order to complete the delivery task (prior to which the driver cannot begin traveling to another location). It should be understood that different orders may have different time-on-site constraints (e.g., one order may be associated with a constraint reflecting that the driver is likely to need 8 minutes to complete the delivery while another order may be associated with a constraint reflecting that the driver is likely to need 15 minutes to complete the delivery).

The described technologies can be further configured to simulate various routes with respect to the referenced synthetic requests. Each such route can be an arrangement or sequence of requests that enables each request to be completed in accordance with the respective associated constraints of each request (e.g., among a set of requests). For example, dispatch engine 142 and/or an external service (e.g., a navigation or routing application/service) can generate multiple sequences/arrangements that dictate the manner in which each synthetic request (e.g., in a set of requests, such as requests for a simulated day) can be completed in accordance/consistent with the respective constraints of each request.

Scoring engine 143 can be, for example, an application, module, set of instructions, etc., configured to rate, score, or otherwise ascribe a value or metric to the various generated routes, such as those generated in the manner described herein. In certain implementations, scoring engine can include or incorporate function(s) such as a cost function that reflects factor(s) based on which such routes are to be evaluated. For example, such a cost function can correspond to the time interval/duration required to complete a route. Accordingly, using such an example cost function, routes that complete their included requests in relatively less time can be identified and scored as ‘better’ or higher quality as compared to other routes that require relatively more time to complete all included requests. It should be understood that such a cost function is provided by way of example and any number of other function(s) can be implemented in substantially comparable way(s).

Based on the scores generated by scoring engine 143, neural network 144 can be trained. In certain implementations, such a model can be trained using reinforcement learning, supervised learning, and/or other such techniques. For example, based on the scores reflecting which simulated routes are more optimal than others (e.g., in that all included requests can be completed in a relatively shorter time), neural network 144 can be trained to identify and/or compute such routes.

Having trained neural network 144, the neural network can be used with respect to subsequently received requests/orders (e.g., real-world orders). To do so, the described technologies can utilize an inference phase, as described in further detail herein. For example, as shown in FIG. 1, various real-world requests 146A, 146B, etc., can be received, e.g., from service(s) 128. Such real-world requests 146 can correspond to or reflect orders to be delivered and can be associated with respective constraints 148. Such constraints can reflect, for example, the location to which the request is to be delivered, a time window during which it is to be delivered, etc., as described herein.

The described technologies can process such received requests, e.g., by projecting them onto the domain with respect to which neural network 144 was trained. For example, a distance matrix can be computed or generated (e.g., by an external service or engine) based on such respective delivery destinations. Such a distance matrix can reflect, for example, travel times between respective geographic locations corresponding to the received real-world requests 146. Then, using multi-dimensional scaling techniques and the generated distance matrix, respective virtual locations can be computed (e.g., with respect to each of the real-world requests).

By way of illustration, as shown in FIG. 1, server 120 can receive various orders which may be associated with different delivery locations 150A, 150B, 150C (which may be locations within a defined geographic area 170A, e.g., New York, as shown in FIG. 1). Each of the referenced delivery locations can correspond to a real-word location such as an address, geographic coordinates, etc. Using an external service or engine (e.g., a navigation application configured to compute directions between geographic points), a distance matrix can be generated. Such a distance matrix can reflect the expected travel time between various points (e.g., travel time between 150A and 150B; travel time between 150B and 150C, etc.).

Using the referenced distance matrix, various virtual locations can be computed or generated (e.g., using a multi-dimensional scaling algorithm or another such technique). As noted, such virtual locations can reflect the travel time/Euclidean distance between such points. Based on the computed virtual locations, neural network 144 can compute an optimized routing of the received orders (e.g., based on the model that was trained using synthetic requests and simulated routes). Such an optimized routing can account for available driver(s) and the time-window and/or other constraints associated with the respective orders, as described herein. As noted, in certain implementations, such a routing can be computed in relation to Euclidean space.

Having computed the referenced optimized route (in Euclidean space) via neural network 144, the route can be transformed or transposed into network space. For example, utilizing an external navigation engine, the route computed by neural network 144 can be transformed in relation to the underlying real-world locations and/or distances associated with the respective received orders. Aspects of the transformed routing can then be provided to respective users (e.g., by dispatching drivers to respective destinations in accordance with the optimized routing).

It should be understood that by training and implementing the described neural network with respect to Euclidean space (as opposed to network space), numerous advantages can be realized. For example, routing a set of orders with respect to Euclidean space can require substantially less computing resources (as compared to network space). Moreover, training a neural network based on network space data originating from one geographic area (e.g., New York City) may be of limited applicability with respect to routing orders in another area (e.g., Los Angeles). As a result, by training the model with respect to Euclidean space, the resulting model can be effectively employed in routing orders, even in other locations.

For example, as shown in FIG. 1, the described technologies can be utilized to optimize routes in multiple geographic locations. For example, orders associated with another set of delivery locations 150X, 150Y, 150Z (which may be locations within a defined geographic area 170B, e.g., Los Angeles, as shown in FIG. 1) can be received. Each of the referenced delivery locations can correspond to a real-word location such as an address, geographic coordinates, etc. Using neural network 144, an optimal route can be generated in a manner comparable to that described above. As noted, by training the model in Euclidean space (and by projecting subsequent requests into Euclidean space), the model can be utilized effectively with respect to orders/routes in different places (e.g., New York and Los Angeles). In contrast, a model trained based on real-world inputs from one area (e.g., New York) may be ineffective when applied to requests in another area (e.g., Los Angeles).

Having computed an optimized route via neural network 144 with respect to a set of requests, dispatch engine 142 (e.g., an application, module, etc., configured to instruct or direct drivers 130 to complete such requests) can dispatch such orders/requests to various drivers 130.

By way of further illustration, in certain implementations various constraints can be defined or determined with respect to a particular request/order, product, etc. Such constraints can reflect various parameters, ranges, etc., within or with respect to which the referenced item(s), order(s), etc. are to be prepared, delivered, etc. Examples of such constraints include but are not limited to: time-window constraints pertaining to chronological interval(s) within which a particular order is to be delivered (e.g., between 09:00 and on a particular date), other time constraints reflecting when an order must leave a store, etc., in order to meet customer expectations, and/or other such customer expectations (which can vary, for example, with respect to a fixed delivery time, a particular timeframe, a certain time duration after an order is placed, etc.), temperature control requirements (e.g., for safety/health purposes, such as a frozen item only being safe if left out of a cold environment for one hour or less), etc.

In certain implementations, the referenced constraints may be defined or determined by certain users (e.g., an administrator or authorized user associated with a store, as described herein). Additionally, in certain implementations the referenced constraints can be defined, determined, and/or computed (e.g., in an automated or dynamic manner) based on other constraints and/or other information provided to and/or accessed by the system (e.g., inputs, data, etc. originating from various devices and/or sensors).

By way of example, the referenced constraints can be defined as a predetermined time interval (e.g., an amount of time from receipt of the order that the order is to be prepared, dispatched for delivery, and/or delivered). In certain implementations, such a constraint can be defined or determined based on inputs or other information originating from certain sensor(s) or devices. For example, with respect to a frozen item, such a constraint can dictate that the item must be delivered before the item reaches a defined temperature, state, etc. (e.g., a frozen item must be delivered before it reaches a certain temperature, humidity level, etc.).

The referenced constraints can also reflect a time derived or determined based on another constraint. By way of example, based on a constraint reflecting that an order must be out for delivery no later than 20 minutes after it has been received, additional constraints can be computed reflecting a time by which the preparation, retrieval, packaging, etc. of various items must begin (e.g., a milkshake, which takes six minutes to prepare, must begin no later than 14 minutes after the order is received, while a scoop of ice cream, which take two minutes to prepare, must begin no later than 18 minutes after the order is received, in order to meet the referenced minute delivery constraint).

Additionally, in certain implementations the referenced constraints can be computed based on a customer expectation or guarantee. For example, orders that are prepared can wait a certain period of time before being dispatched for delivery, though such orders must be dispatched no later than 10 minutes before the delivery time/estimate provided to the customer. Accordingly, in such a scenario, corresponding constraint(s) can be defined to reflect the referenced order dispatch requirement(s) (as computed based on the delivery time/estimate provided to the user).

It should be understood that though FIG. 1 depicts server 120 and devices 110 as being discrete components, in various implementations any number of such components (and/or elements/functions thereof) can be combined, such as within a single component/system.

It should also be noted that, in certain implementations, the described technologies (e.g., device 110, application(s) 111 and/or 112, dispatch engine 142, server 120, etc.) can provide valuable insights and/or updates to various participants. For example, the described technologies may provide drivers, delivery personnel, etc. with an interface through which information or updates regarding requests/orders and items can be accessed, viewed, and/or received.

It should also be noted that while various aspects of the described technologies are described with respect to delivery dispatch, such descriptions are provided by way of example and the described technologies can also be applied in many other contexts, settings, and/or industries. For example, the described technologies can also be implemented in settings/contexts such as taxi service, drones, and/or any other such services, such as services that leverage the location and/or capabilities of various participants/candidates and route tasks, jobs, etc., to such devices, users, etc., in a manner that enables such tasks, etc., to be efficiently completed (and/or completed in an effective manner, e.g., fastest, most cost effectively, etc.).

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

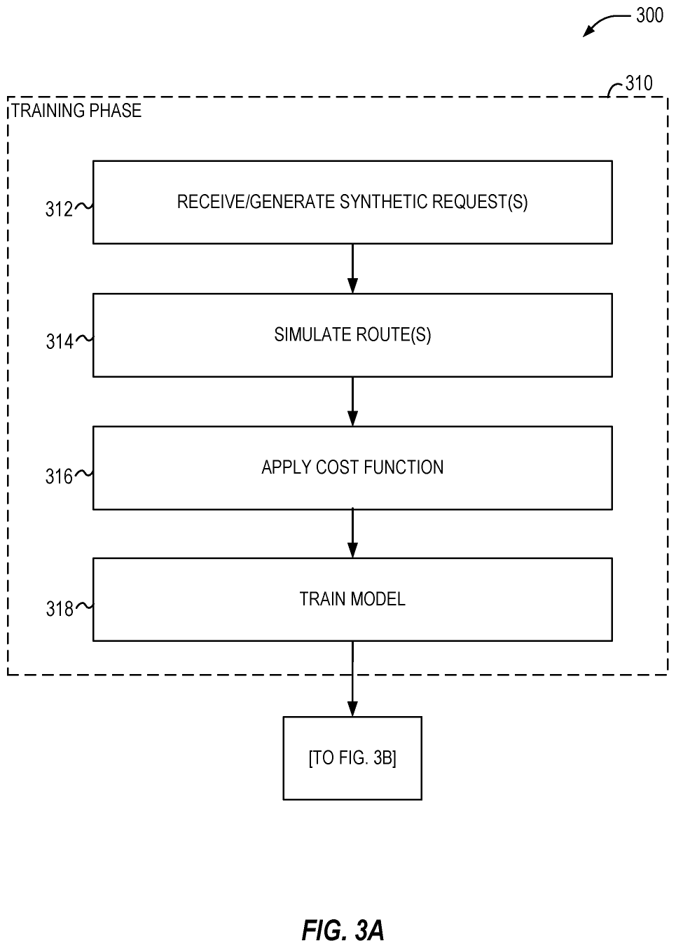

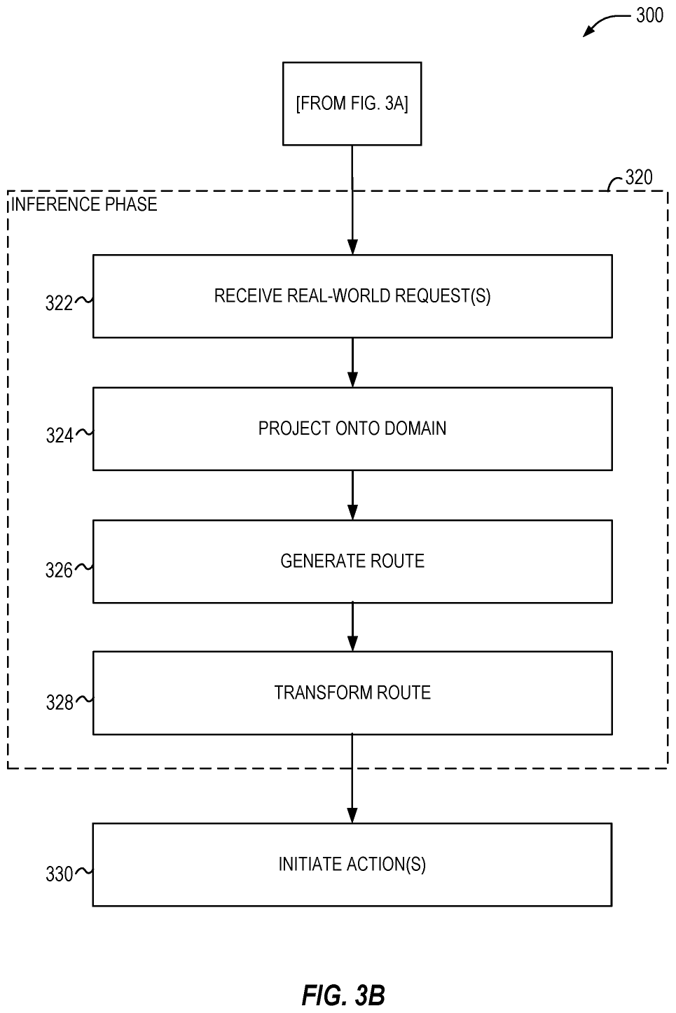

FIGS. 3A-3B depict flow charts illustrating a method 300, according to an example embodiment, for neural network-based routing using time-window constraints. The method is performed by processing logic that can comprise hardware (circuitry, dedicated logic, etc.), software (such as is run on a computing device such as those described herein), or a combination of both. In one implementation, the method 300 is performed by one or more elements depicted and/or described in relation to FIG. 1 (including but not limited to server 120, dispatch engine 142, neural network 144, and/or devices 110), while in some other implementations, the one or more blocks of FIGS. 3A-3B can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

As shown in FIG. 3A, a training phase 310 can be initiated, as described herein. In certain implementations, such a training phase can be initiated using reinforcement learning techniques. Such a training phase can be utilized to train a model (e.g., neural network 144). Such a model can be utilized to generate optimized routes, as described in detail herein.

At operation 312, one or more requests can be received or otherwise generated, as described herein. In certain implementations, such requests can be synthetic requests 147, such as those generated (e.g., by request generator 145) to reflect parameters included in delivery requests or orders.

For example, the referenced synthetic requests can include or incorporate location coordinates or other such geographic identifiers. In certain implementations, such location coordinates can be randomly generated, e.g., within a defined set of geographic constraints. Such constraints can reflect, for example, locations within a defined area (e.g., a city, state, radius from a certain point, etc.).

By way of further example, the referenced synthetic requests can include or incorporate time window(s). In certain implementations, such time windows can be randomly or artificially generated, e.g., within a defined set of time-window constraints. Such constraints can reflect, for example, a chronological interval during which a request is to be fulfilled (e.g., delivery of an order between 10:00 AM and 11:00 AM).

It should be understood that the referenced constraints are provided by way of example, and that any number of additional constraints can also be incorporated. For example, in certain implementations the referenced synthetic requests can further include or incorporate randomly generated time-on-site constraints. Such constraints can reflect, for example, an amount of time a driver may need to spend after arriving at a delivery site prior to being able to begin traveling to another destination.

At operation 314, one or more routes can be simulated, as described herein. For example, the described technologies can simulate multiple routes, each of which reflect a navigation sequence that includes locations corresponding to each of the one or more synthetic requests (e.g., those received at 312). An example route can reflect a sequence that enables a driver to complete each of the received requests while accounting for the various constraints associated with each request (e.g., the respective location of each request, time window for each request, etc.).

At operation 316, a cost function is applied, e.g., to each of the simulated routes (such as those generated at 314). In certain implementations, such a cost function can reflect a time duration required for completion of the route. For example, each simulated route can be assigned a score based on the time required to complete the route (with shorter times corresponding to a ‘better’ or closer to optimal score). In certain implementations, such scoring operation(s) can be deployed via scoring engine 143.

At operation 318 the model (e.g., neural network 144) can be trained. For example, based on the determined quality of the simulated routes (as generated at 316, e.g., by scoring engine 143), the described technologies can utilize reinforcement learning techniques to train the referenced model. Doing so can, for example, train the model to identify and/or compute routes optimized for time. Additionally, in certain implementations the model can be trained to artificially generate routes, e.g., based on the determined quality of the simulated routes.

FIG. 3B depicts aspects of an inference phase 320. In certain implementations, such an inference phase can be initiated once the referenced model has been trained.

At operation 322, one or more real-world requests can be received. It should be understood that such real-world requests may correspond in certain ways to the synthetic requests received at 312 and described above. However, in contrast to the synthetic requests (which can be randomly generated), the described real-world requests reflect actual requests/orders, e.g., being received in real time. Accordingly, each of the referenced real-world requests can include constraints such as real-world coordinates (e.g., geographic coordinates, delivery address), real-world time windows (e.g., a time window for delivering a particular order), and/or real-world time-on-site intervals (e.g., an amount of time a driver may need to spend after arriving at a delivery site before traveling to another destination).

At operation 324, the received real-world requests (e.g., as received at 322) can be projected onto a domain on which the model was trained (e.g., as described with respect to training phase 310). In doing so a distance matrix can be generated. Such a distance matrix can reflect a fully-connected graph that represents travel times between the geographic locations from the received real-world requests. Based on the generated distance matrix, using multi-dimensional scaling technique(s), various virtual locations can be computed. Such virtual locations can reflect locations in Euclidean space that correspond to locations associated with the underlying real-word orders.

At operation 326, a route is generated. In certain implementations, such a route can be generated with respect to the one or more virtual locations (e.g., as computed at 324). It should be understood that distances between coordinates can represent the travel times between various locations associated with respective requests. Moreover, in certain implementations such a route can be generated using the model (e.g., neural network 144) as trained in training phase 310 based on various simulated routes, as described herein.

At operation 328, the route, as generated using the model (e.g., at 326), can be transformed into one or more real-world geographic coordinates. For example, the route computed using the model in Euclidean space (e.g., at 326) can be transformed into corresponding real-world geographic coordinates.

At operation 330, one or more actions can be initiated with respect to the one or more real-world geographic coordinates (e.g., as transformed at 328). For example, aspects of the transformed route can be provided to respective users (e.g., by dispatching drivers to respective destinations in accordance with the optimized routing), as described herein.

It should also be noted that while the technologies described herein are illustrated primarily with respect to the delivery of food, items, services, etc., the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a processor or other programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 4 is a block diagram illustrating components of a machine 400, according to some example implementations, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein can be executed. The instructions 416 transform the machine into a particular machine programmed to carry out the described and illustrated functions in the manner described. In alternative implementations, the machine 400 operates as a standalone device or can be coupled (e.g., networked) to other machines. In a networked deployment, the machine 400 can operate in the capacity of a server machine or a client machine in a server-client network environment, or as a peer machine in a peer-to-peer (or distributed) network environment. The machine 400 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 can include processors 410, memory/storage 430, and I/O components 450, which can be configured to communicate with each other such as via a bus 402. In an example implementation, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 412 and a processor 414 that can execute the instructions 416. The term “processor” is intended to include multi-core processors that can comprise two or more independent processors (sometimes referred to as “cores”) that can execute instructions contemporaneously. Although FIG. 4 shows multiple processors 410, the machine 400 can include a single processor with a single core, a single processor with multiple cores (e.g., a multi-core processor), multiple processors with a single core, multiple processors with multiples cores, or any combination thereof.

The memory/storage 430 can include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 can also reside, completely or partially, within the memory 432, within the storage unit 436, within at least one of the processors 410 (e.g., within the processor's cache memory), or any suitable combination thereof, during execution thereof by the machine 400. Accordingly, the memory 432, the storage unit 436, and the memory of the processors 410 are examples of machine-readable media.

As used herein, “machine-readable medium” means a device able to store instructions (e.g., instructions 416) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions, when executed by one or more processors of the machine (e.g., processors 410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 can include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 can include many other components that are not shown in FIG. 4. The I/O components 450 are grouped according to functionality merely for simplifying the following discussion and the grouping is in no way limiting. In various example implementations, the I/O components 450 can include output components 452 and input components 454. The output components 452 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 450 can include biometric components 456, motion components 458, environmental components 460, or position components 462, among a wide array of other components. For example, the biometric components 456 can include components to detect expressions (e g, hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 can include acceleration sensor components (e.g., accelerometer), gravitation sensor components, rotation sensor components (e.g., gyroscope), and so forth. The environmental components 460 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 462 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 450 can include communication components 464 operable to couple the machine 400 to a network 480 or devices 470 via a coupling 482 and a coupling 472, respectively. For example, the communication components 464 can include a network interface component or other suitable device to interface with the network 480. In further examples, the communication components 464 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 can be another machine or any of a wide variety of peripheral devices (e.g., a peripheral device coupled via a USB).

Moreover, the communication components 464 can detect identifiers or include components operable to detect identifiers. For example, the communication components 464 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 464, such as location via Internet Protocol (IP) geolocation, location via Wi-Fi® signal triangulation, location via detecting an NFC beacon signal that can indicate a particular location, and so forth.

In various example implementations, one or more portions of the network 480 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 can include a wireless or cellular network and the coupling 482 can be a Code Division Multiple Access (CDMA) connection, a Global System for Mobile communications (GSM) connection, or another type of cellular or wireless coupling. In this example, the coupling 482 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 416 can be transmitted or received over the network 480 using a transmission medium via a network interface device (e.g., a network interface component included in the communication components 464) and utilizing any one of a number of well-known transfer protocols (e.g., HTTP). Similarly, the instructions 416 can be transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense

What is claimed is:

1. A system comprising:
a processing device; and
a memory coupled to the processing device and storing instructions that, when executed by the processing device, cause the system to perform operations comprising:
initiating, using reinforcement learning techniques, a training phase to train a model, the training phase comprising:
receiving one or more synthetic requests, each of the one or more synthetic requests comprising one or more coordinates randomly generated within a defined first set of constraints, one or more time windows artificially generated within a defined second set of constraints, and one or more time-on-site intervals randomly generated within a defined third set of constraints;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route; and
training the model to artificially generate routes based on the determined quality of the simulated routes;
initiating an inference phase, the inference phase comprising:
receiving one or more real-world requests, each of the one or more real-world requests comprising one or more real-world coordinates, one or more real-world time windows, and one or more real-world time-on-site intervals;
projecting the received one or more real-world requests onto a domain on which the model was trained by:
generating a distance matrix that reflects a fully-connected graph representing travel times between respective geographic locations corresponding to the one or more real-world requests; and
computing, using one or more multi-dimensional scaling techniques and based on the distance matrix, one or more virtual locations;
using the model as trained based on the simulated routes, generating a route with respect to the one or more virtual locations;
transforming the route, as generated using the model, into one or more real-world geographic coordinates; and
initiating one or more actions with respect to the one or more real-world geographic coordinates.

2. A method comprising:
initiating, using reinforcement learning techniques, a training phase to train a model, the training phase comprising:
receiving one or more synthetic requests, each of the one or more synthetic requests comprising one or more coordinates randomly generated within a defined first set of constraints, one or more time windows artificially generated within a defined second set of constraints, and one or more time-on-site intervals randomly generated within a defined third set of constraints;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route; and
training the model based on the determined quality of the simulated routes;
initiating an inference phase, the inference phase comprising:
receiving one or more real-world requests, each of the one or more real-world requests comprising one or more real-world coordinates, one or more real-world time windows, and one or more real-world time-on-site intervals;
projecting the received one or more real-world requests onto a domain on which the model was trained by:
generating a distance matrix that reflects a fully-connected graph representing travel times between respective geographic locations corresponding to the one or more real-world requests; and
computing, using one or more multi-dimensional scaling techniques and based on the distance matrix, one or more virtual locations;
using the model as trained based on the simulated routes, generating a route with respect to the one or more virtual locations;
transforming the route, as generated using the model, into one or more real-world geographic coordinates; and
initiating one or more actions with respect to the one or more real-world geographic coordinates.

3. A non-transitory computer readable medium having instructions stored thereon that, when executed by a processing device, cause the processing device to perform operations comprising:
initiating, using reinforcement learning techniques, a training phase to train a model, the training phase comprising:
receiving one or more synthetic requests, each of the one or more synthetic requests comprising one or more coordinates randomly generated within a defined first set of constraints, one or more time windows artificially generated within a defined second set of constraints, and one or more time-on-site intervals randomly generated within a defined third set of constraints;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route; and
training the model based on the determined quality of the simulated routes;
initiating an inference phase, the inference phase comprising:
receiving one or more real-world requests, each of the one or more real-world requests comprising one or more real-world coordinates, one or more real-world time windows, and one or more real-world time-on-site intervals;
projecting the received one or more real-world requests onto a domain on which the model was trained by:
generating a distance matrix that reflects a fully-connected graph representing travel times between respective geographic locations corresponding to the one or more real-world requests; and
computing, using one or more multi-dimensional scaling techniques and based on the distance matrix, one or more virtual locations;
using the model as trained based on the simulated routes, generating a route with respect to the one or more virtual locations;
transforming the route, as generated using the model, into one or more real-world geographic coordinates; and
initiating one or more actions with respect to the one or more real-world geographic coordinates.

4. A system comprising:
a processing device; and
a memory coupled to the processing device and storing instructions that, when executed by the processing device, cause the system to perform operations comprising:
receiving one or more synthetic requests;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route;
training a model based on the determined quality of the simulated routes;
receiving one or more real-world requests;
projecting the received one or more real-world requests onto a domain on which the model was trained;
using the model as trained based on the simulated routes, generating a route with respect to the one or more virtual locations computed with respect to the one or more real-world requests;
transforming the route, as generated using the model, into one or more real-world geographic coordinates; and
initiating one or more actions with respect to the one or more real-world geographic coordinates.

5. A method comprising:
receiving one or more synthetic requests;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route;
training a model based on the determined quality of the simulated routes;
receiving one or more real-world requests;
projecting the received one or more real-world requests onto a domain on which the model was trained;
using the model as trained based on the simulated routes, generating a route with respect to the one or more virtual locations computed with respect to the one or more real-world requests;
transforming the route, as generated using the model, into one or more real-world geographic coordinates; and
initiating one or more actions with respect to the one or more real-world geographic coordinates.

6. A non-transitory computer readable medium having instructions stored thereon that, when executed by a processing device, cause the processing device to perform operations comprising:
receiving one or more synthetic requests;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route;
training a model based on the determined quality of the simulated routes;
receiving one or more real-world requests;
projecting the received one or more real-world requests onto a domain on which the model was trained;
using the model as trained based on the simulated routes, generating a route with respect to the one or more virtual locations computed with respect to the one or more real-world requests;
transforming the route, as generated using the model, into one or more real-world geographic coordinates; and
initiating one or more actions with respect to the one or more real-world geographic coordinates.

7. A system comprising:
a processing device; and
a memory coupled to the processing device and storing instructions that, when executed by the processing device, cause the system to perform operations comprising:
receiving one or more synthetic requests, each of the one or more synthetic requests comprising one or more coordinates randomly generated within a defined first set of constraints, one or more time windows artificially generated within a defined second set of constraints, and one or more time-on-site intervals randomly generated within a defined third set of constraints;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route; and
training a model based on the determined quality of the simulated routes.

8. A method comprising:
receiving one or more synthetic requests, each of the one or more synthetic requests comprising one or more coordinates randomly generated within a defined first set of constraints, one or more time windows artificially generated within a defined second set of constraints, and one or more time-on-site intervals randomly generated within a defined third set of constraints;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route; and
training a model based on the determined quality of the simulated routes.

9. A non-transitory computer readable medium having instructions stored thereon that, when executed by a processing device, cause the processing device to perform operations comprising:
receiving one or more synthetic requests, each of the one or more synthetic requests comprising one or more coordinates randomly generated within a defined first set of constraints, one or more time windows artificially generated within a defined second set of constraints, and one or more time-on-site intervals randomly generated within a defined third set of constraints;
simulating one or more routes, each of the one or more routes comprising a navigation sequence that includes locations corresponding to each of the one or more synthetic requests;
applying a cost function to each of the one or more simulated routes to determine the quality of the simulated routes, wherein the cost function reflects a time duration required for completion of the route; and
training a model based on the determined quality of the simulated routes.

10. A system comprising:
a processing device; and
a memory coupled to the processing device and storing instructions that, when executed by the processing device, cause the system to perform operations comprising:
receiving one or more real-world requests, each of the one or more real-world requests comprising one or more real-world coordinates, one or more real-world time windows, and one or more real-world time-on-site intervals;
projecting the received one or more real-world requests onto a domain on which a model was trained by:
generating a distance matrix that reflects a fully-connected graph representing travel times between respective geographic locations corresponding to the one or more real-world requests; and
computing, using one or more multi-dimensional scaling techniques and based on the distance matrix, one or more virtual locations;
using the model as trained based on the simulated routes, generating a route with respect to the one or more virtual locations;
transforming the route, as generated using the model, into one or more real-world geographic coordinates; and
initiating one or more actions with respect to the one or more real-world geographic coordinates.

11. A method comprising:
receiving one or more real-world requests, each of the one or more real-world requests comprising one or more real-world coordinates, one or more real-world time windows, and one or more real-world time-on-site intervals;
projecting the received one or more real-world requests onto a domain on which a model was trained by:
generating a distance matrix that reflects a fully-connected graph representing travel times between respective geographic locations corresponding to the one or more real-world requests; and
computing, using one or more multi-dimensional scaling techniques and based on the distance matrix, one or more virtual locations;
using the model as trained based on the simulated routes, generating a route with respect to the one or more virtual locations;
transforming the route, as generated using the model, into one or more real-world geographic coordinates; and
initiating one or more actions with respect to the one or more real-world geographic coordinates.

12. A non-transitory computer readable medium having instructions stored thereon that, when executed by a processing device, cause the processing device to perform operations comprising:
receiving one or more real-world requests, each of the one or more real-world requests comprising one or more real-world coordinates, one or more real-world time windows, and one or more real-world time-on-site intervals;
projecting the received one or more real-world requests onto a domain on which a model was trained by:
generating a distance matrix that reflects a fully-connected graph representing travel times between respective geographic locations corresponding to the one or more real-world requests; and
computing, using one or more multi-dimensional scaling techniques and based on the distance matrix, one or more virtual locations;
using the model as trained based on the simulated routes, generating a route with respect to the one or more virtual locations;
transforming the route, as generated using the model, into one or more real-world geographic coordinates; and
initiating one or more actions with respect to the one or more real-world geographic coordinates.

13. A system comprising:
a processing device; and
a memory coupled to the processing device and storing instructions that, when executed by the processing device, cause the system to perform operations comprising:
initiating, using one or more reinforcement learning techniques, a training phase to train a model, wherein initiating the training phase comprises:
receiving one or more synthetic requests, each of the one or more synthetic requests comprising one or more coordinates randomly generated within a defined first set of constraints, one or more time windows generated within a defined second set of constraints, and one or more time-on-site intervals generated within a defined third set of constraints;
simulating one or more routes, each of the one or more routes comprising a navigation sequence that includes locations corresponding to each of the one or more synthetic requests;
determining the quality of the simulated routes by applying a function that reflects a time duration required for completion of the route; and
training the model to generate routes based on the determined quality of the simulated routes.

14. The system of claim 13, wherein the instructions further cause the system to perform operations comprising:
initiating an inference phase, the inference phase comprising:
receiving one or requests, each of the one or more requests comprising one or more coordinates, one or more time windows, and one or more time-on-site intervals;
projecting the received one or more requests onto a domain on which the model was trained by:
generating a distance matrix that reflects a graph representing travel times between respective geographic locations corresponding to the one or more real-world requests; and
computing, using one or more scaling techniques and based on the distance matrix, one or more virtual locations;
using the model as trained based on the simulated routes, generating a route with respect to the one or more virtual locations;
transforming the route, as generated using the model, into one or more geographic coordinates; and
initiating one or more actions with respect to the one or more real-world geographic coordinates.
